(19) United States
(12) Patent Application Publication
(10) Pub. No.: US 2013/0300048 A1
(43) Pub. Date: Nov. 14, 2013

(54) Smooth Disengagement with Quick Clamping Mechanism

(71) Applicant: Ruey Teng Chen, Scottsdale, AZ (US)

(72) Inventor: Ruey Teng Chen, Scottsdale, AZ (US)

(21) Appl. No.: 13/887,317

(22) Filed: May 4, 2013

Related U.S. Application Data
(60) Provisional application No. 61/688,243, filed on May 9, 2012.

(51) Int. Cl. B25B 1/10

(52) U.S. Cl. CPC B25B 1/10
USPC 269/246

(57) ABSTRACT

A Smooth Disengagement with Quick Clamping Mechanism designed for increasing efficiency and improving the quality of clamping systems that can be used in various vises, C-clamps and all other clamping applications. This invention applies a concept of using two sets of opposing thread angles; one thread set is used at engagement, while the other is used at clamping. By using these two sets of opposing helix angles it creates opposing axial forces against each other, so as to force the clamping thread set to rotate first in the process of releasing a clamping force. This function would prevent a sudden drop in clamping force; a problem most quick clamping designs having in the industry.

And, a collar jam preventing device that can stop a collar in the radial direction before it bumps into an axial dead end, which causes a tight jam and becomes hard to crank in the subsequent working cycle.

### CROSS-REFERENCE TO RELATED APPLICATIONS

This application claims benefit as a continuation application of provisional U.S. patent application Ser. No. 61/688,243 filed May 9, 2012, with Title of Invention listed as “A Vise Increasing Clamping Force: . . . ” are hereby incorporated by reference in their entirety.

### BACKGROUND OF THE INVENTION AND PRIOR ARTS

This invention relates to C-clamps and vises, which not only provides a quick positioning method but also improves the releasing operation to prevent a sudden drop in force that occurs in most quick positioning C-clamps and vises. Also, included in this invention, a radial instead of axial end stop at the end of a retrieving cycle which can provide a smooth start movement for the subsequent cycle avoiding axial dead end stoppage that occurs in the prior art.

Listed below are U.S. patents describing various clamping systems include: U.S. Pat. No. 298,704 issued to Norris et al. on May 13, 1884; U.S. Pat. No. 754,962 issued to Bennett on Mar. 22, 1904; U.S. Pat. No. 825,151 issued on McLean on Jul. 3, 1906; U.S. Pat. No. 947,619 issued to Orr on Jan. 25, 1910; U.S. Pat. No. 1,140,646 issued to Abernathy on May 25, 1915; U.S. Pat. No. 2,372,727 issued to Manning on Apr. 13, 1945; U.S. Pat. No. 2,430,458 issued to Farrell on Nov. 11, 1947; U.S. Pat. No. 3,357,698 issued to Flynn on Dec. 12, 1967; U.S. Pat. No. 3,245,676 issued to Floren, et al. on Apr. 12, 1966; U.S. Pat. No. 3,492,886 issued to Naureckas on Feb. 3, 1970; U.S. Pat. No. 3,704,014 issued to Keene, Robert F. on Nov. 28, 1972; U.S. Pat. No. 4,083,624 issued to Timmer on Apr. 11, 1978; U.S. Pat. No. 4,262,892 issued to Wu on Apr. 21, 1981; U.S. Pat. No. 4,534,547 issued to Cox on Aug. 13, 1985; U.S. Pat. No. 4,753,427 issued to Lodrick, Sr., on Jun. 28, 1988; U.S. Pat. No. 4,925,169 issued to Lodrick, Sr., on May 15, 1990; U.S. Pat. No. 5,241,736 issued to Allison on Sep. 7, 1993; U.S. Pat. No. 6,098,973 issued to Khachatoorian on Aug. 8, 2000; U.S. Pat. No. 6,250,621 issued to Ping on Jun. 26, 2001; U.S. Pat. No. 6,296,241 issued to Harrison on Oct. 2, 2001; U.S. Pat. No. 6,726,193 issued to Yates on Apr. 27, 2004; U.S. Pat. No. 6,938,891 issued to Yates on Sep. 6, 2005, and US Application Publication 2010/0244338 A1 issued to Stephen Castor, Justin Blake Castor, Brandon Castor on Sep. 30, 2010. Each of these patent is hereby incorporated by reference.

Details in prior Arts: Of some particular interests in the above prior patents that share designs with the collar concept or with other nomenclatures in their patents, describe various purposes of their designs that can be noted by the disclosures of this patent with its unique opposing threaded external and internal threads in the collar design, such as:
A. U.S. Pat. No. 947,619 issued to Orr, Asa A. on Jan. 25, 1910, discloses a clamping wrench. The patent describes the use of a sleeve in item 16 FIG. 5 providing the same idea of a plurality of planar receptors of U.S. Pat. No. 6,726,193 and U.S. on Apr. 27, 2004 issued to Yates and then U.S. Pat. No. 6,938,891 on Sep. 6, 2005 for a rod positioning in their insert designs will be described hereinafter.
B. Especially and most importantly in U.S. Pat. No. 2,372,727 issued to Manning, Harry D. on Apr. 13, 1945, had disclosed the idea of plural surfaces of multiple flat square hole plates 8 as landing positioning and the cut-off spacing of multiple plates 7 can accommodate the square teeth of shank 3 to rotate and move in for engagement. When the square shank 3 and the square holes align then the shank can quickly move through shown at FIG. 3 and FIG. 6. The general concept of a plurality of flat plates for positioning and external thread of sleeve 2 for screwing to increase clamping force were later used also in Yates' two invention patents.
C. Most of other patents are not relevant to this invention, like U.S. Pat. No. 3,245,676, dated Apr. 12, 1966, to Floren, et al., discloses a “Quick Acting Plastic Service T Clamp” even having a C-shaped frame fitted with an interiorly-threaded sleeve adjustably mounted in one of the parallel frame members at one end of the frame by means of a set screw, however this is just a workstock-engaging member provided with a threaded collar which engages the interior threads of the sleeve. The workstock engaging member is adjusted with respect to the workstock by sliding the rod and sleeve through the frame.
D. U.S. Pat. No. 3,704,014, issued on Nov. 28, 1972, to Keene, Robert F. is a “Quick Adjustable C-clamp” with the two slots 20 and 36 to form a notched wall of a pocket permitting the nut equipped screw 24 to be adjusted lengthwise in the slot to achieve the full line position shown in FIG. 2 and its phantom line nut adjusting position shown in the same view. It is a quick manual adjustment but in a fixed position as the length is adjustable by the rectangle nut. The width of the first slot 20 embraces the screw but allows the screw to be shifted and adjusted from right to left and vice versa. The relatively wide slot 36 serves for adjusting of the screw and the nut 28 in a manner to accomplish the in-use and out-of-use positions illustrated in FIG. 2.

E. The plurality of receptors is used as a concept of positioning after a quick movement of a clamp rod to forms the idea of U.S. Pat. No. 6,296,241 issued to Harrison, John P. on Oct. 2, 2001; if referring to FIGS. 4, 5 and of the drawings, the slotted cylinder 10 includes a slotted cylinder bore 10a and a pair of spaced-apart, parallel, longitudinal cylinder slots 11 having a set of spaced-apart transverse pin slots 12 extending peripherally from each of the longitudinal cylinder slots 11 as illustrated in FIG. 4. Referring again to FIGS. 4 and 5 of the drawings that any number of pin slots 12 can be provided in the slotted cylinder 10 at any selected spacing with respect to each other depending on the desired quick adjusting capability of the clamp rod 14 in the slotted cylinder 10.
F. U.S. Pat. No. 6,726,193 issued to Yates, Howard Preston on Apr. 27, 2004, as a “Quick position clamp and vise” uses the same idea of a plurality of planar receptors as of U.S. Pat. No. 947,619 of Orr, Ma A. on Jan. 25, 1910 as aforementioned above. And, the idea of the four square corners in symmetrical worked as receptors is very similar to U.S. Pat. No. 2,372,727 issued to Manning, Harry D. on Apr. 13, 1945 to allow a square shank to move quickly through square holes of plates in sleeve. However, during the disengagement, the square threads would slide out to cause a sudden drop as it is still under a high axial pressure. In his vise design of Yates' patent also uses the same concept as in its C-clamp; in FIGS. 8 through 11 the threaded insert 16 has been broached by a square broach leaving partial thread teeth 26 where a square bar 20 with square thread teeth 28 would engage in, but would still slip out in the time of disengaged.
G. Following the above patent of Yates, Howard Preston, a second patent is subsequently issued in second year on Sep. 6, 2005, which is U.S. Pat. No. 6,938,891. It is still following the same idea for a quick axial movement of square rod when it is disengaged and aligned with the insert 16; and when it is engaged, then the square rod is positioned in the receptors for further clamping by using the outer thread of insert 16. There is no further design of any feature of preventing sudden drop.
H. US Application Publication 2010/0244348 A1 issued to Stephen Castor, Justin Blake Castor, Brandon Castor on Sep. 30, 2010 as a “Adjustable C-clamp”, is similar to the idea of U.S. Pat. No. 6,296,241 issued to Harrison, John P. on Oct. 2, 2001. In FIG. 2 shows the C-clamp 100 of the present invention disassembled, and shows ridge 200, locking device 210, and hole 220. In FIG. 5˜8, clamp rod 170 is shown in the interior of cylinder 160 with locking device 210 in the deep part of groove 410. As for locking/engaged position, which is different from this invention, their clamp rod 170 is rotated in a first direction, locking device 210 moves towards the shallow side of groove 410 and substantially locks clamp rod 170 to the interior 400 of cylinder 160. This locked position prevents the clamp rod 170 from sliding within the interior 400.

These prior arts using plurality of flat surfaces as their position/receptors have the disadvantage of a sudden drop when a handle unscrews to release clamping. It is because the flat plural surfaces have much less friction, so the driving rod has to move first and slip out of the flat plural surfaces to make a sudden drop under a great clamping pressure. The less friction disables the flat plural surfaces ability to hold the position and immediately let go and drop, which is because the surfaces are flat and they are also far closer to the axial center line compared to their counter part of the clamping thread located at a further radial edge for providing more torque force. Unless the engaged/locking device increases much more torque, it has to rotate and slip out. So, this invention comes to the idea to use two sets of opposing thread angles while the engagement threads replace the plural flat surfaces and are against the axial movement of the clamping threads in releasing the clamping force. The sudden drop causes a quality issue of making a loud thumping noise and causing a bad working environment; a problem that most quick clamping designs have in the industry. The second portion of this invention is using sheet metal to form a tube or using an existing tube as raw material to fabricate the inner collar, which later is placed within an outer collar to form a complete collar. This manufacturing method is much more economical than any other manufacturing methods. The third portion of this invention is a radial stop design in the quick clamping mechanism that prevents a collar from hitting and jamming into a nut body in a clamping release cycle, which is found in prior arts.

### BRIEF SUMMARY OF THE INVENTION

As described above of the problem of a sudden drop happens in using the plural flat surfaces for their position/receptors in prior arts, this invention uses opposing helix thread against its clamping thread's helix angle to prevent “slipping” on plural flat surfaces. These two opposing helix angle thread sets are placed mainly for two different functions one function is for engagement while the other is for clamping threads to screw and clamp working piece. These two sets of opposing threads can be placed in one area around a collar where the collar and a flat threaded rod make up an engagement thread set, and the collar and a nut body make up a clamping thread set. The other case is to apply the two sets of opposing threads two separated areas, then the engagement thread set is formed by the nut body and the flat threaded rod while the clamping thread set is formed by a handle sleeve and a full matched thread at the left end of flat threaded rod. The interact of these two opposing helix angles can create opposing axial forces against each other in clamping releasing cycle to force the clamping thread set to rotate first in releasing the clamping force. When the clamping thread set rotate to release the clamping force it can prevent a sudden drop as the engagement thread set stays still with no “slip out”.

The second feature of this invention is to stop dead end jamming of a collar into a nut body. It provides a solution with a set of radial stops so the collar in retrieving axially would be stopped in its radial rotation before axially moving to bump and jam into the end surface of a nut body.

### BRIEF DESCRIPTION OF VIEWS OF THE DRAWINGS

FIG. 1 shows a complete quick vise and two sets of threads of opposing helix angles (24 and 25) in one collar, and a radial jam preventing device (17 and 23).

FIG. 2 shows two opposing helix angle threads in one collar; and a jam-preventing device in an enlarged scale.

FIG. 3 shows the helix angle on an outer clamping thread of the outer collar.

FIG. 4 shows alternative thread stops in an inner collar.

FIG. 5 shows a section view of FIG. 4 with one of alternative thread stops.

FIG. 6 shows the outer collar of right side view of FIG. 2 with two components of Jam preventing device.

FIG. 7 shows the helix angle on a flat threaded rod, which is opposing to FIG. 4.

FIG. 8 shows two blocking stops on the thread end of the flat threaded rod.

FIG. 9 shows the engagement of inner and outer engagement threads.

FIG. 10 shows the disengagement of inner and outer engagement threads.

FIG. 11 shows the mechanism used on a C-clamp.

FIG. 12 shows the mechanism used on the different application on machine vise.

FIG. 13 shows use the C-clamp concept on a vise.

FIG. 14 shows the concept of two sets of opposing helix angles is separated in two areas (24 and 25).

FIG. 15 shows the right side view of FIG. 14, as an engagement of the flat threaded rod and the nut body.

### LIST OF COMPONENTS

Item 10 handle
Item 11 moveable jaw
Item 12 shaft stop
Item 13 vise body
Item 14 snap ring
Item 15 collar
Item 15a inner collar
Item 15b outer collar
Item 16 nut body
Item 17 peg stop
Item 18 screws
Item 19 flat threaded rod
Item 20 end plate
Item 21 thread stops
Item 21-Alt thread stops
Item 22 working piece.
Item 23 collar stop
Item 24 engagement thread set
Item 24a inner engagement thread
Item 24b outer engagement thread
Item 25 clamping thread set
Item 25a inner clamping thread
Item 25b outer clamping thread
Item 30 coil spring
Item 31 ball-head bar
Item 32 handle sleeve

### DETAILED DESCRIPTION OF THE INVENTION

Description of Mechanism: As there are two different applications of this invention and for the purpose of conveying the concept, the following will be using a collar as an example to explain the mechanism and the function of two opposing angles in one location. After the concept is clearly understood, then it will be easier for the other application in two separated locations, which will be described in subsequent sections.

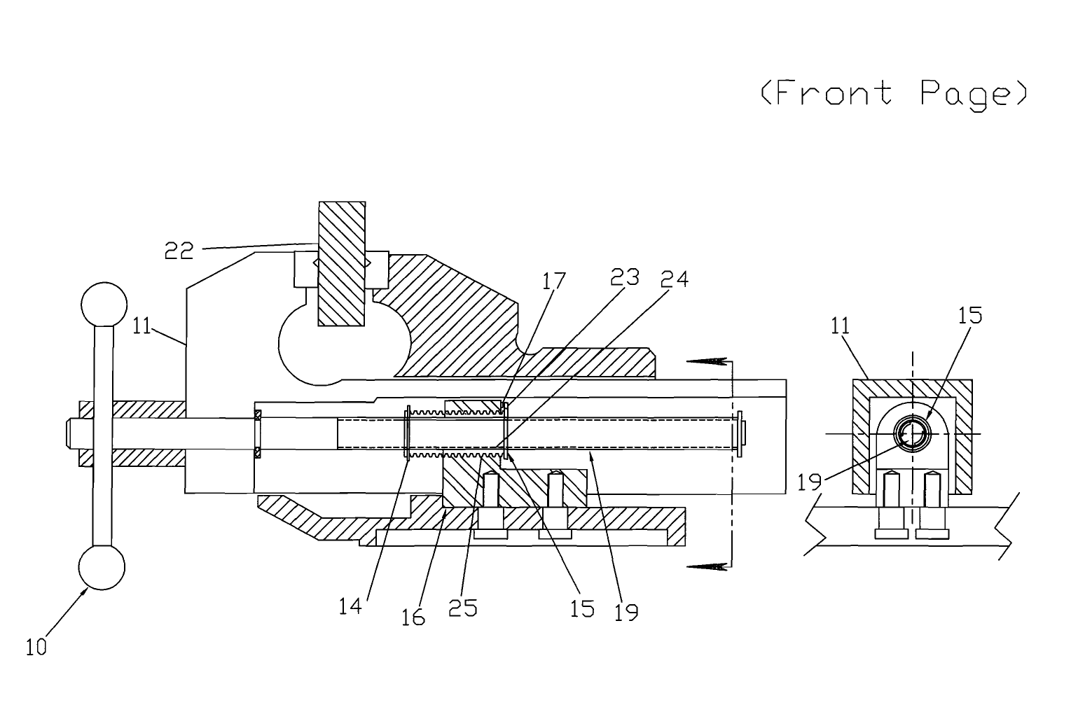

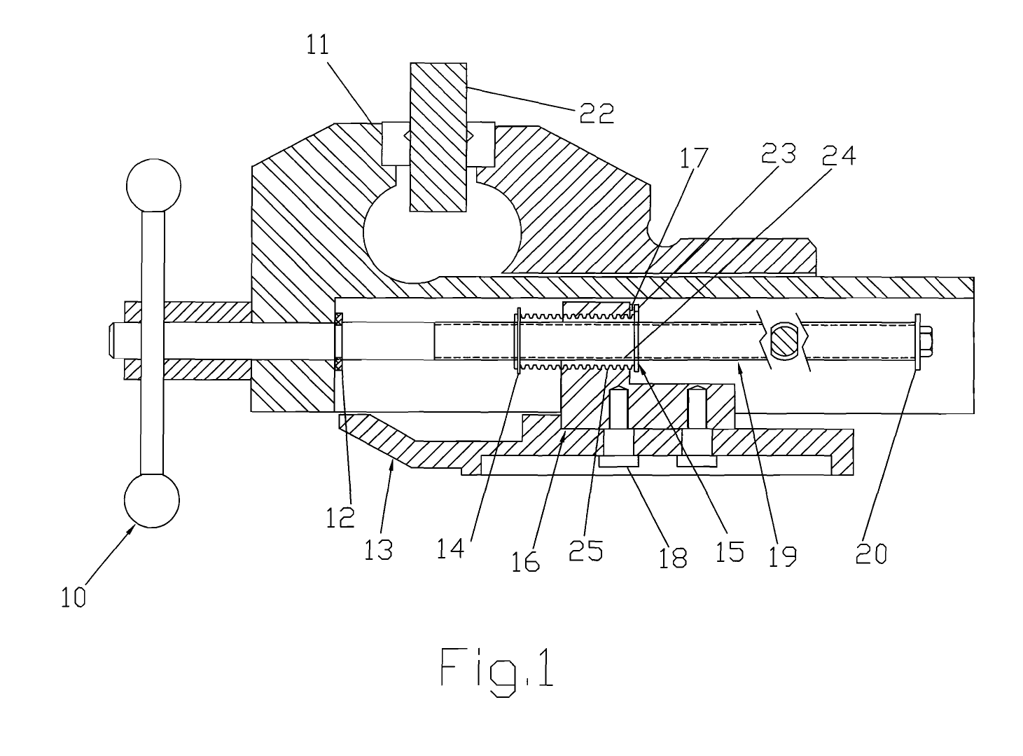

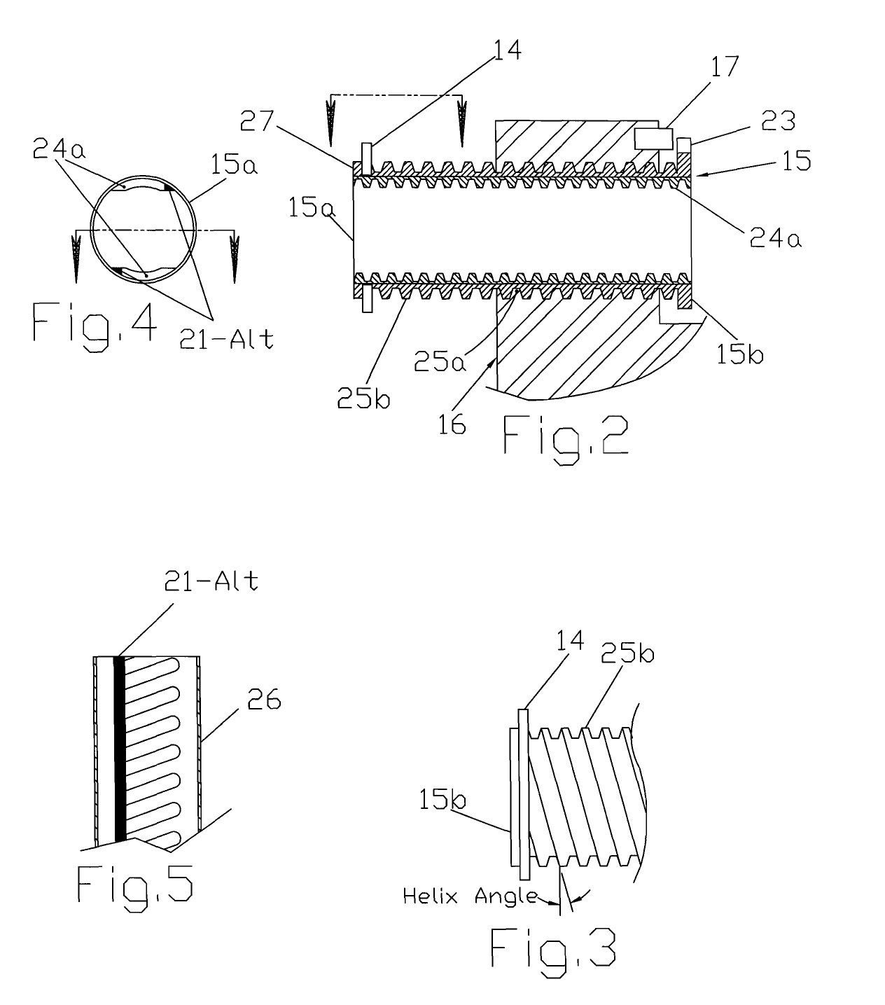

FIG. 1 shows a complete vise set that uses two sets of threads but in opposing helix angles; one is located at engagement thread set 24 while the other is located at clamping thread set 25. And, their opposing angles are shown on FIG. 3 and FIG. 7 separately. The engagement thread set 24 comprises an inner engagement thread 24a of a collar 15 and an outer engagement thread 24b of a flat threaded rod 19, while the clamping thread set 25 comprises an inner clamping thread 25a of the collar 15 and an outer clamping thread 25b of a nut body 16. The details are shown in an enlarged scale of the collar 15 area in FIG. 2. These two sets of opposing helix angles is the key point of the invention in preventing a sudden drop in clamping pressure impact when handle 10 is rotated in reverse to release clamping force during high pressure clamping, and will be explained in detail next in “Description of functions”. The collar 15 used in the example comprises an inner collar 15a and an outer collar 15b as shown in FIGS. 2, 4 and 6, but it can be a whole piece of tube containing two threads as well. The inner engagement thread of inner collar 15a is cut into two segments of roughly 90-degree occupancy of its circumference and symmetrically facing each other as shown in FIG. 4. The flat threaded rod 19 can be engaged with inner collar 15a as shown in FIG. 9 or not engaged as shown in FIG. 10, where the flat threaded rod can be freely and quickly moved in the axial direction. A peg stop 17 firmly located in a nut body 16 will prevent collar 15 from jamming into the end surface of the nut body 16 by halting a collar stop 23 so to stop the rotation of collar 15 in a releasing/retrieving cycle of handle 10. The stop of collar 15 will initiate the disengagement of the inner collar 15a with the flat threaded rod 19 as it is still rotating; the function will be detailed next in “Description of Functions”, also.

Description of function: The mechanism description above depicted ideas of the concept of this invention with its purpose of smooth disengagement in releasing clamping power. A continuous explanation of the function as follows will bring us into a more complete picture of the invention's integrity as a whole. After the handle 10 axially moves to push a movable jaw 11 in contacting a working piece 22 while the flat threaded rod is in the position shown in FIG. 10, then it is time for further cranking by the handle 10. Before the clamping actually happens, the rotation of the flat threaded rod 19 will engage with the inner engagement thread 24a of collar 15 and then stopped by thread stops 21 to form a full engagement as indicated in FIG. 9. Then, the continuous rotation of the flat threaded rod 19 will rotate with the collar 15 as a whole so its outer clamping thread 25b screws into the inner clamping thread 25a of the nut body 16 and also creates axial movement to clamp the work piece 22 in one or two pitches advancing outer clamping thread 25b in handle cranking. This completes the work of clamping work piece 22. After completion of required works on 22, then it comes the process of releasing clamping force through reverse rotation where a smooth release will occur as opposed to a sudden pressure drop; in the conventional design the plural flat surfaces would slip out the engagement and allow a sudden release of the high axial clamping force. As this design's engagement thread set 24 uses a helix angle opposing to that of clamping thread set 25, so with a releasing rotation of handle 10 it creates an advancing movement forward to increase the engagement force forming high torque, and forces the outer clamping thread 25b to screw outward to create a smooth release. In other words, the engagement thread set 24 with opposite helix angle against that of clamping thread set 25 when engaged in high axial pressure forces clamping thread set 25 to release the axial clamping force through following its own thread's helix angle. The continuous reverse rotation of collar 15 will draw back until the peg stop 17 stops the collar stop 23, allowing the turning of flat threaded rod 19 to disengage from the inner engagement thread 24a with a 90-degree turn as the thread stops 21 interferes the continuous rotation of the device, which then returns to the position shown in FIG. 10. This position of no further rotation allows the flat threaded rod 19 to perform free backward axial movement and releases the working piece 22 for the next cycle. This completes the entire description of the mechanism and functions of this invention.

Benefits in fabrication: The present invention of using inner collar 15a can provide a great saving in manufacturing as it can be stamped out of a piece of sheet metal or a thin tube as shown in FIG. 4 and FIG. 5. Besides, the segmented thread inside the inner collar 15a can be either formed symmetrically or using a conventional thread in segments for an economic manufacturing method. Then, it can be firmly placed and fixed in the outer collar 15b to form a complete collar 15 as shown in FIG. 2. The thread stops 21 of the flat threaded rod 19 can be made as welds, thread-smashed, inserts, etc. With the same function, the thread stop 21 can be replaced by the thread stops 21-Alt in inner collar 15a as an alternative manufacturing method shown in FIGS. 4 and 5. As mentioned above while making inner collar 15a, the thread stops can be stamped with the segmented threads.

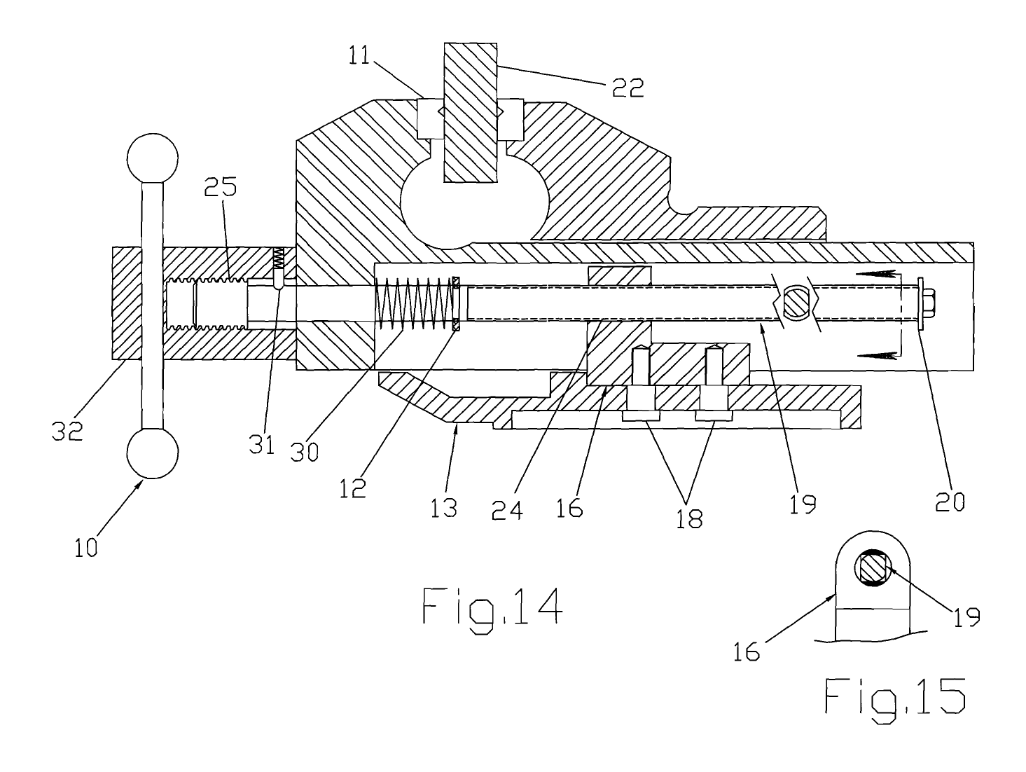

The use of concept in two locations: This is another application of the two sets of opposing helix angles of this invention but in two separated locations. FIG. 14 and its right side view of FIG. 15 are used for further explanation and description. The engagement thread set 24, as named by the engagement of 24a and 24b, is placed where the flat threaded rod 19 and the nut body 16 engage at the center portion of the vise; while the clamping thread set 25, as named by the engagement of 25a and 25b, is placed where the flat threaded rod 19 and handle sleeve 32 are matched at the left end of FIG. 14.

A ball-head bar 31 is vertical/radial spring pressed into a pre-formed concave as a detainer located in the flat threaded rod 19 about a depth of ⅓ of its half ball-head diameter; the purpose of the ball-head bar 31 in the concave is to form a resistant force to drive the flat threaded rod 19. Now, it can start from the position in FIG. 10 for further clamping of working piece 22 after the handle 10 axially moves to push a movable jaw 11 in contacting a working piece 22, then it is the time for further cranking by the handle 10. Before the clamping actually happens, the rotation of the flat threaded rod 19 driven by the ball-head bar 31 will engage with the inner engagement thread 24a of nut body 16 and stopped by thread stops 21 to form a full engagement as indicated in FIG. 15 and at the same time stop the rotation of the flat threaded rod 19. After that, the continuous cranking of the handle 10 can only rotate the handle sleeve 32 to the left end of the clamping thread 25b of the flat threaded rod 19 creating axial movement to clamp the work piece 22 in one or two pitches advancing the inner clamping thread 25a with handle 10 cranking. A coil spring 30 is to keep the movable jaw 11 always in touch with the end surface of handle sleeve 32 in axial movement and at the same time yields space to allow the clamping thread 25b to screw on 25a of 19 to create a high-pressure clamping force on working piece 22. After completion of required works on 22, it is time for the subsequent processes of releasing clamping force. The reverse cranking of the handle 10 would drive the handle sleeve 32 to unscrew first as the engagement thread set 24 with a helix angle opposing to that of 25 moves forward to increase the engagement force in forming even higher torque, which forces the inner clamping thread 25a to screw out to make a smooth release. After that, the unscrewing of the handle sleeve 32 would drive the ball-head bar 31 back into the concave where 31 originally located. The resistant force enables the ball-head bar to drive and rotate the flat threaded rod 19 to disengage the nut body 16 roughly 90-degree and then stop when it hits the thread stops 21 and to be in the position shown in FIG. 10. After that the flat threaded rod 19 can freely move axially to release the working piece 22 and move to the next clamping cycle as required.

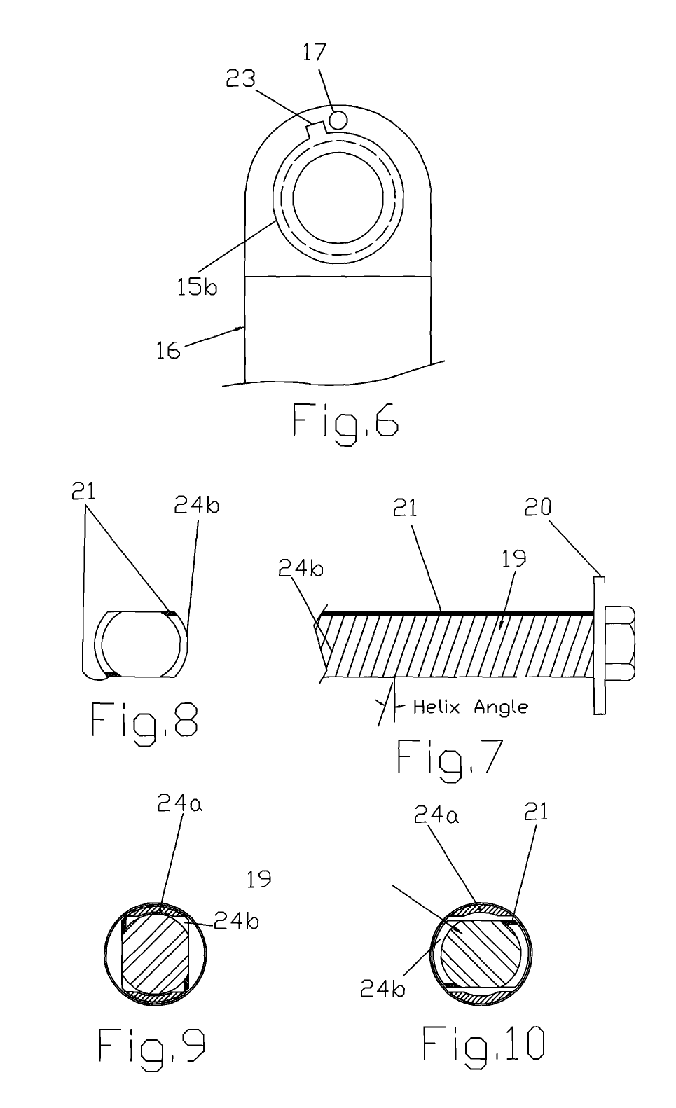

A collar jam preventing device comprising a peg stop 17 firmly located at the nut body 16 and a collar stop 23 at collar 15 as shown in FIGS. 2 and 6, offers a radial stop concept. During the clamping releasing cycle, this device provides a radial stop to prevent the collar 15 from axially jamming into the surface of the nut body 16. The retrieving of the collar 15 by making reverse turns and screwing back will stop when the collar stop 23 hits the peg stop 17 before the collar 15 axially moves to bump into the nut body 16 thereby preventing jam formation. Without jamming, it makes the subsequent working cycle much smoother for the handle 10 to crank.

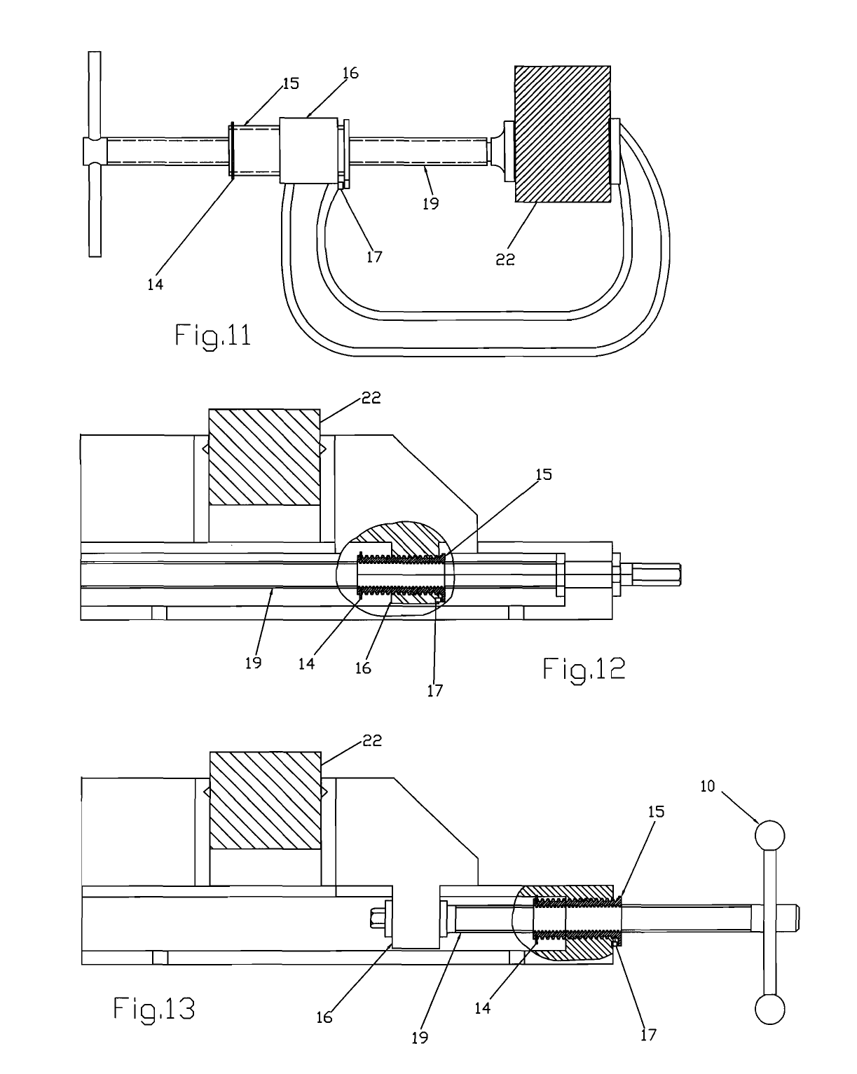

FIG. 11 indicates the invention that is applied to a C-clamp while FIG. 12 and FIG. 13 indicate the invention can be variously used on different vises. Nonetheless, they all use the same concept of two sets of threads with opposite helix angles, which can prevent a sudden drop in releasing clamping pressure.

### CONCLUSION

Although there have been described many special embodiments of the current invention of Smooth Disengagement with Quick Clamping Mechanism, it is not intended that such references be construed as limitations on the scope of this invention. Having thus fully disclosed and described my invention, I claim:

What is claimed is:

1. A smooth disengagement mechanism, comprising a flat threaded rod and two sets of threads with opposite helix angles where one is an engagement thread set while the other is a clamping thread set; and, the flat threaded rod can either turn into engagement or disengagement.

2. The smooth disengagement mechanism of claim 1, wherein the two threads of opposite helix angles are formed in one collar where the inner engagement threads are formed at the inside diameter and the outer clamping thread is formed at the outside diameter.

3. The smooth disengagement mechanism of claim 1, wherein the two sets of threads with opposite helix angles can also be formed in two separated areas; the engagement thread set is at its matched area of a nut body and a flat threaded rod, and the clamping thread set is at its matched area of a handle sleeve and a flat threaded rod.

4. The smooth disengagement mechanism of claim 1, wherein the thread stops are placed either on the flat threaded rod or on the inner engagement threads; and they are made with welds, thread-smashed, inserts, etc.

5. The smooth disengagement mechanism of claim 1 or claim 2, wherein the outer clamping thread of a collar is formed into one or multiple segments; the numbers of segment can be 1, 2, 3, 4 or 5, etc.

6. The smooth disengagement mechanism of claim 1 or claim 2, wherein the inner engagement thread of a collar has at least 2 segments, which are either formed symmetrically or formed as a conventional thread in segments; the numbers of segment are 2, 3, 4, or 5, etc.

7. A collar, comprising an inner collar and an outer collar, the inner collar has at least two inner engagement segments, the segment is either a flat surface or a surface with an angle.

8. The collar of claim 7, wherein the inner engagement segments of inner collar are either formed symmetrically or a conventional thread but in segments; the numbers of segment are 2, 3, 4, or 5, etc.

9. A collar jam preventing device, comprising a peg stop and a collar stop at a collar provides a rotation stop in radial position before the collar axially jams into a nut body.

10. The collar jam preventing device of claim 9, wherein the peg stop and the collar stop can be a welded peg, stud, screw head, etc.; they can also be cast or formed together with their substrates.
